(19) United States
(12) Patent Application Publication
(10) Pub. No.: US 2026/0264205 A1
(43) Pub. Date: Sep. 10, 2026

(54) TENSIONING DEVICE AND METHOD FOR TENSIONING A THREADED ROD

(71) Applicant: AKTIEBOLAGET SKF, GOTEBORG (SE)

(72) Inventor: Didier DECLERCK, Acheres (FR)

(21) Appl. No.: 19/550,435

(22) Filed: Feb. 26, 2026

(30) Foreign Application Priority Data
Mar. 5, 2025 (DE) 102025108211.1

(51) Int. Cl. B25B 29/02

(52) U.S. Cl. CPC B25B 29/02

(57) ABSTRACT

A tensioning device for tensioning a threaded rod includes a cylindrical tie having a threaded inner opening and a bottom surface having an annular opening surrounding the threaded inner opening. The threaded inner opening has a longitudinal axis and is configured to threadedly engage a thread of the threaded rod. An annular piston is slidably mounted in the annular opening to form an annular compression chamber. A valve has a first opening in fluid communication with the compression chamber and a second opening, and a coupling is mounted in the second opening. The coupling is configured to releasably and rotatably connect to another coupling to couple the compression chamber to a source of pressurized fluid.

### CROSS-REFERENCE

This application claims priority to German patent application no. 10 2025 108 211.1 filed on Mar. 5, 2025, the contents of which are fully incorporated herein by reference.

### TECHNOLOGICAL FIELD

The present disclosure is directed to the field of devices for tensioning a rod before it is locked in position, for example using a nut. The disclosure is also directed to a tensioning device and a method for tensioning a threaded rod in particular of a rotary assembly.

### BACKGROUND

Tensioning devices generally comprise an actuator that is able to exert an axial traction force on one end of a threaded rod by way of a tie. The actuator bears on a surface of a structure to be clamped via a tubular skirt surrounding one end of the threaded rod, opposite the end subjected to the axial force of the actuator.

The actuator comprises a cylinder and a piston sliding in the cylinder and forming with the cylinder an annular chamber that can be supplied with a fluid under pressure. The fluid under pressure is supplied by external supplying means which are connected to the tensioning device by a hose.

In certain applications, particularly when the tensioning device must tension a rotatable assembly, the hose may prevent the tensioning device from rotating.

### SUMMARY

It is therefore an aspect of the present disclosure to provide a tensioning device which can be mounted on a threaded rod of a rotatable assembly.

The disclosure concerns a tensioning device of a threaded rod, the tensioning device comprising: a cylindrical tie having an outer peripheral surface and an inner peripheral surface with a threaded part able to be screw to the threaded rod; an annular piston configured to slide relative to the cylindrical tie in an annular compression chamber; a pipe with an end connected to the annular compression chamber; a valve connected to another end of the pipe which valve is configured to allow or prevent a circulation of fluid in the pipe, the valve being fixed relative to the cylindrical tie; and a coupling device connected to the valve and provided with rotative coupling means to a complementary coupling device of external means for supplying a pressurized fluid.

According to a general feature, a direction of connection of the coupling device to the complementary coupling device is parallel to a longitudinal axis of the threaded part of the cylindrical tie so that when the coupling device is connected to the complementary coupling device, the coupling devices can rotate relatively to each other around the longitudinal axis.

The coupling device of the valve make it possible to rotate the tensioning device while pressure is maintained in the annular compression chamber and while the complementary coupling device of external means for supplying a pressurized fluid is still connected to the coupling device.

Advantageously, the cylindrical tie has an annular recess formed between the outer and inner peripheral surfaces, the annular piston being able to slide into the annular recess and forming together with the cylindrical tie the annular compression chamber.

In one embodiment, the tensioning further comprising a connector connecting the valve to an upper surface of the cylindrical tie, the upper surface being opposed to a lower surface of the tie from which is formed the recess. In another embodiment, the valve is partly embedded inside the cylindrical tie.

The disclosure also concerns a tensioning assembly comprising a tensioning device as defined above and means for supplying a pressurized fluid having the complementary coupling device, the coupling devices being able to rotate relatively to each other around the direction of connection. Advantageously, one of the coupling devices of the valve and of the external means comprises male rotative coupling means having a circumferential groove, the other of the coupling devices comprising female rotative coupling means having a plurality of locking balls arranged circularly and able to engage into the circumferential groove. The means for supplying a pressurized fluid may have a hose connected to the complementary coupling device.

The disclosure also concerns a method to tension a threaded rod of a rotary assembly, with the tensioning assembly as defined above, comprising the steps of: connecting the threaded rod to the threaded part of the cylindrical tie, supplying a pressurized fluid with the means for supplying a pressurized fluid to the annular compression chamber for tensioning the threaded rod, closing the valve and releasing the pressure in the complementary coupling device, and rotating the tensioning device and the threaded rod around a longitudinal axis of the threaded rod while the annular compression chamber contains the pressurized fluid.

During the step of rotating the tensioning device and the threaded rod, the threaded rod is fixed relative to the tensioning device. Advantageously, the step of closing the valve also comprises releasing the pressure in the hose, and in the coupling device. Advantageously, the rotary assembly is supported by a bearing.

### BRIEF DESCRIPTION OF THE DRAWINGS

Other advantages and features of the disclosure will appear from the detailed description of an embodiment of the disclosure, which is a non-limiting example, illustrated on the appended drawings of which:

FIG. 1 is a sectional side elevational view of a tensioning assembly according to an embodiment of the present disclosure.

FIG. 2 is a flow chart illustrating a method to tension a threaded rod according to an embodiment of the disclosure.

### DETAILED DESCRIPTION

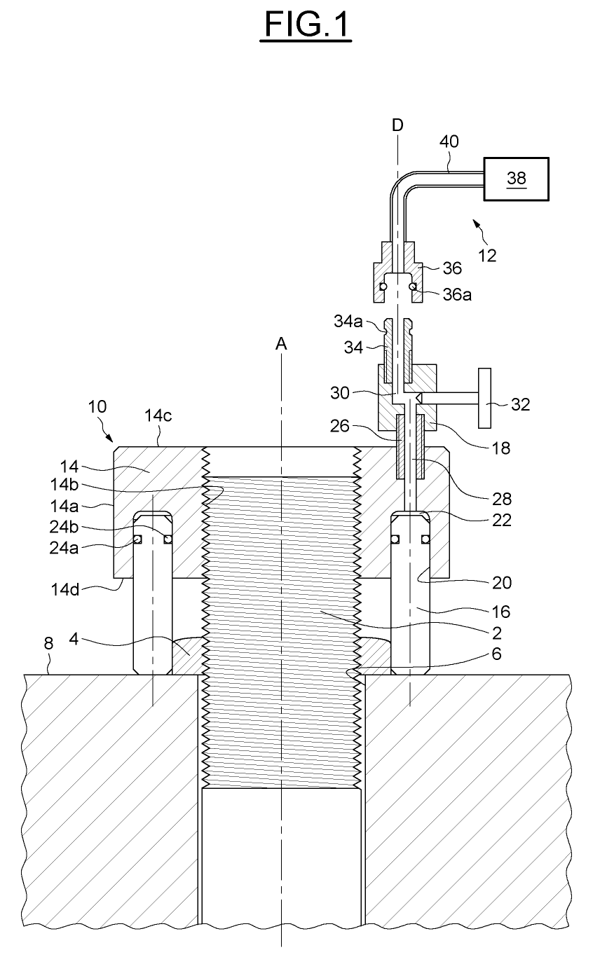

FIG. 1 illustrates a tensioning assembly for tensioning a threaded rod 2 locked by a nut 4, where the threaded rod 2 extends along a longitudinal axis A. The threaded rod 2 is inserted in a hole 6 of a rotatable assembly having a surface 98. The rotatable assembly may be supported by a bearing. The nut 4 is placed around the threaded rod 2 such that it is in contact with the surface 8 of the rotatable assembly.

The tensioning assembly comprises a tensioning device 10 and means for supplying a pressurized fluid 12. The tensioning device 10 comprises a cylindrical tie 14, an annular piston 16 and a valve 18.

The cylindrical tie 14 has an outer peripheral surface 14a, an inner peripheral surface 14b with a threaded part screwed to the threaded rod 2, an upper surface 14c axially opposed to (facing axially away from) the surface 8 of the rotatable assembly, and a lower surface 14d axially facing the surface 8 of the rotatable assembly. The cylindrical tie 14 also has an annular recess 20 formed into its thickness between the outer and inner peripheral surfaces and opening onto the lower surface 14d.

The annular piston 16 can slide axially relative to the cylindrical tie 14 into the annular recess 20 of the cylindrical tie 14. The annular piston 16 forms together with the cylindrical tie 14 an annular compression chamber 22 inside the cylindrical tie 14. The annular piston 16 has an outer peripheral surface provided with an annular groove in which an outer seal 24a is arranged. The outer seal 24a is in contact with the cylindrical tie 14 and with the annular piston 16. The annular piston 16 has an inner peripheral surface provided with an annular groove in which an inner seal 24b is arranged. The inner seal 24b is in contact with the cylindrical tie 14 and with the annular piston 16.

The annular piston 16 is fixed relative to the surface 8 of the rotatable assembly, and here in contact with the surface 8 of the rotatable assembly. Alternatively, the tensioning assembly may comprises a spacer piece between the annular piston 16 and the surface 8 of the rotatable assembly.

The valve 18 is fixed relative to the cylindrical tie 14. More precisely, the tensioning assembly comprises a tubular connector 26 connecting the valve 18 to the upper surface of the cylindrical tie 14, the tubular connector 26 extending parallel to the longitudinal axis A of the threaded rod 2. Alternatively, the valve 18 may be partly embedded inside the cylindrical tie 14.

The tensioning assembly also comprises a pipe 28 (sometime referred to as a passageway) connecting the annular compression chamber 22 to the valve 18. More precisely, the pipe 28 extends axially through the cylindrical tie 14 and the tubular connector 26, from the annular compression chamber 22 to the valve 18. The pipe 28 may be formed by the cylindrical tie 14 and the tubular connector 26 or alternatively may be secured to the cylindrical tie 14 and the tubular connector 26.

The valve 18 further comprises a duct 30 connected to the pipe 28 and means for allowing and stopping a circulation of fluid inside the duct 30, for example a handwheel 32 or an electric actuator. The tensioning assembly further comprises a coupling device 34 connected to the valve 18, in particular connected to the duct 30 of the valve 18. The means for supplying a pressurized fluid 12 comprises a complementary coupling device 36.

The coupling device 34 is provided with rotative coupling means 34a to the complementary coupling device 36 of the means for supplying a pressurized fluid 12. The coupling device 34 extends parallel to the longitudinal axis A of the threaded rod 2. The direction of connection D of the coupling device 34 to the complementary coupling device 36 is parallel to the longitudinal axis A.

When the coupling device 34 is connected to the complementary coupling device 36, the coupling device 34 and the complementary coupling device 36 can rotate relatively to each other around the direction of connection D when the valve 18 is closed, the pressure released in both coupling device 34 and complementary coupling device 36, and the pressure maintained in the annular compression chamber 22.

The coupling device 34 comprises male rotative coupling means 34a having a circumferential groove. The complementary coupling device 36 comprises female rotative coupling means 36a having a plurality of locking balls arranged circularly and able to engage into the circumferential groove. The coupling device 34 and the complementary coupling device 36 may be devices known as quick connect nipple and quick coupling.

The means for supplying a pressurized fluid 12 further comprises a tank 38 of pressurized fluid, a pump to control the pressure of the pressurized fluid, and a hose 40, which may be flexible, connected to the complementary coupling device 36 to distribute the pressurized fluid.

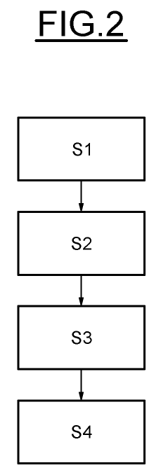

FIG. 2 schematically illustrates a method to tension the threaded rod 2 with the tensioning assembly.

The method starts with step S1 of connecting the threaded rod 2 to the threaded part 14b of the cylindrical tie 14. The step S1 may also comprises the connection of the means for supplying a pressurized fluid 12 to the valve 18, namely the connection of the complementary coupling device 36 to the coupling device 34.

The method continues with step S2 of supplying the pressurized fluid with the means for supplying a pressurized fluid 12 to the annular compression chamber 22 for tensioning the threaded rod 2. In particular, the pressurized fluid at the desired pression is supplied through the valve 18 to the annular compression chamber 22 to obtain a hydraulic pressure able to move the cylindrical tie 14 away from the piston 16, thus tensioning the threaded rod 2 and permitting to tighten the nut 4.

The method continues with step S3 of closing the valve 18 to stop the circulation of the pressurized fluid inside the duct 30. The step S3 also comprises stopping the pump and releasing the pressure between the tank 38 and the complementary coupling device 36, in particular releasing the pressure in the hose 40, in the coupling device 34 and in the complementary coupling device 36. The means for supplying a pressurized fluid 12 are still connected to the valve 18 by the complementary coupling device 36 connected to the coupling device 34. By closing the valve 18 and releasing the pressure between the tank 38 and the complementary coupling device 36, an operator may check the rotatable assembly supported by the bearing.

The method ends with step S4 of rotating the tensioning device 10 and the threaded rod 2 around the longitudinal axis A of the threaded rod 2 while the annular compression chamber 22 contains the pressurized fluid, and in particular contains the hydraulic pressure required to maintain the position of the piston 16 relative to the cylindrical tie 14. The rotation of the cylindrical tie 14 is facilitated by the coupling device 34 which can rotate relative to the complementary coupling device 36, in particular when the pressure is released between the coupling device 34 and the complementary coupling device 36, around the longitudinal axis A of the threaded rod 2, thus facilitating the checking by the operator.

The operator may then apply more pressure in the annular compression chamber 22 to tension more the threaded rod 2. For this purpose, the operator first increases pressure in the pump to obtain a pressure which is at least equal to the pressure in the annular compression chamber 22 before opening valve 18 and repeats steps S3 and S4.

Representative, non-limiting examples of the present invention were described above in detail with reference to the attached drawings. This detailed description is merely intended to teach a person of skill in the art further details for practicing preferred aspects of the present teachings and is not intended to limit the scope of the invention. Furthermore, each of the additional features and teachings disclosed above may be utilized separately or in conjunction with other features and teachings to provide improved tensioning devices.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

What is claimed is:

1. A tensioning device for tensioning a threaded rod, the tensioning device comprising:
a cylindrical tie having an outer peripheral surface, a threaded inner opening and a bottom surface having an annular opening surrounding the threaded inner opening, the threaded inner opening having a longitudinal axis and being configured to threadedly engage a thread of the threaded rod,
an annular piston slidably mounted in the annular opening to form an annular compression chamber between an end of the annular piston and an inner surface of the annular opening,
a valve having a first opening in fluid communication with the annular compression chamber, and
a first coupling fixed to the valve and having a longitudinal axis and being releasably and rotatably connectable to a second coupling of a hose for supplying a pressurized fluid to the valve,
wherein the longitudinal axis of the first coupling is parallel to the longitudinal axis of the central opening such that when the first coupling is connected to the second coupling the second coupling is rotatable about the first coupling.

2. The tensioning device according to claim 1, including a connector connecting the valve to an upper surface of the cylindrical tie.

3. The tensioning device according to claim 1,
wherein the valve is partly embedded in the cylindrical tie.

4. A tensioning assembly comprising:
a tensioning device according to claim 1, and
means for supplying a pressurized fluid, the means for supplying the pressurized fluid including the second coupling.

5. The tensioning assembly according to claim 5
wherein the first coupling is a male coupling and the second coupling is a female coupling or wherein the first coupling is a female coupling and the second coupling is a male coupling, and
wherein the male coupling includes a circumferential groove and wherein the female coupling includes a plurality of locking balls arranged circumferentially and being configured to engage in the circumferential groove.

6. The tensioning assembly according to claim 5,
including the threaded rod, and
a rotatable assembly having an opening,
wherein the threaded rod extends through the opening in the rotatable assembly and engages the threaded inner opening of the tie, and
wherein a second end of the annular piston is mounted on an upper surface of the rotatable assembly such that a pressure increase in the compression chamber biases the tie away from the rotatable assembly.

7. A method for tensioning a threaded rod of a rotary assembly comprising:
providing a tensioning device according to claim 1,
connecting the threaded rod to the threaded inner opening,
supplying a fluid through the valve and the pipe to the annular compression chamber to increase a pressure in the annular pressure chamber and bias the annular piston away from the surface of the annular opening,
closing the valve, and
rotating the tensioning device and the threaded rod around the longitudinal axis of the threaded opening while the valve maintains the fluid under pressure in the annular compression chamber.

8. A tensioning assembly comprising:
a rotatable assembly having an opening having a longitudinal central axis,
a rod extending out of the opening, the rod having a threaded end,
a tie having a threaded inner opening threadably engaged with the threaded end of the rod, a bottom surface facing an upper surface of the rotatable assembly, an annular opening in the bottom surface surrounding the threaded inner opening of the tie and an annular piston slidably mounted in the annular opening to form a compression chamber between a first end of the annular piston and the inner surface of the annular opening, a second end of the annular piston being mounted on the upper surface of the rotatable assembly such that a pressure increase in the compression chamber biases the tie away from the rotatable assembly,
a valve having a first opening in fluid communication with the compression chamber and a second opening from which a first coupling extends,
wherein the first coupling has a central axis and is configured to releasably connect to a second coupling having the central axis in a manner that allows the first coupling to rotate relative to the second coupling around the central axis.

9. The tensioning assembly according to claim 8,
including a hose extending from a source of pressurized fluid, and
the second coupling attached to an end of the hose,
wherein the second coupling is rotatably connected to the first coupling.
